(19) United States
(12) Patent Application Publication
(10) Pub. No.: US 2024/0404530 A1
(43) Pub. Date: Dec. 5, 2024

(54) METHOD AND SYSTEM FOR CAPTURING, STORING, IDENTIFYING AND DISTRIBUTING AN INDIVIDUALS UNIQUE COLLECTIVE VOCAL ATTRIBUTES OR SINGING VOICE AND DYNAMICALLY GENERATING A VOCAL PERFORMANCE USING ARTIFICIAL INTELLIGENCE

(71) Applicant: Todd Andrew Meagher, Keller, TX (US)

(72) Inventor: Todd Andrew Meagher, Keller, TX (US)

(21) Appl. No.: 18/204,487

(22) Filed: Jun. 1, 2023

(51) Int. Cl. G10L 17/26; G10L 13/027; G10L 17/14

(52) U.S. Cl. CPC G10L 17/26; G10L 13/027; G10L 17/14

(57) ABSTRACT

A system for creating a song using vocal attributes extracted from a singing voice of an individual is provided comprising a computer and application executing thereon that digitally captures a plurality of vocal attributes of a singing voice of an individual. The system also processes, normalizes, identifies, and stores the attributes as a voice model. Based on dynamic outputs and digital audio files associated with the model, the system generates a performance of a new song created with the individual's singing voice. The system provides an identifier code for the voice model for storing and indexing the voice model and metadata or tags for identifying and tracking use of the voice model. The vocal attributes comprise at least range, timbre, flexibility, control, vibrato, resonance, articulation, expressiveness, stamina, tone and power of the singing voice and vocal traits comprising use of at least one of feel, phrasing, pronunciations, language, articulation, dynamics, meter, and rhythm. The attributes are captured from a live session with the individual or a recording of the individual's voice.

### FIELD OF THE DISCLOSURE

The present disclosure relates generally to the field of audio processing and the dynamic generation of vocal performances using an individual's voice model. More specifically, the present disclosure provides systems and methods for facilitating creation, identification, and dynamic generation and distribution of a vocalists' vocal performance using their digitally stored vocal attributes or voice model.

### BACKGROUND

Vocal performances are recognized as one of the most widely consumed forms of digital content in the world. While the performance, recording, sale, licensing and distribution of a recorded vocal performance is a major source of revenue for vocalists, it is often costly and requires the assistance of several third parties. Many vocalists often struggle with a lack of access to the resources or to third parties needed to record a vocal performance. Accordingly, vocalists and companies are often required to make sizable time and cash investments in the creation of each recorded vocal performance.

A large portion of recorded vocal performances of interest to the public consists of material recorded by vocalists who are well recognized, well established, or well liked. However, these vocalists' ability to create and record vocal performances may be limited by their resources, their native tongue, their health, and their availability.

As a result, several web-based services have come into existence in the past few years that specifically aim to provide users with tools to copy or clone a vocalists' voice or previously recorded vocal performance and use it to create new vocal performances without the participation, approval or compensation to the vocalist.

As may be evident, there are several problems with the existing methods of creating and distributing vocal performances. Firstly, since human efforts are involved, the vocalist is constrained on the number of recordings they may be able to record due to health or term of life issues. Secondly, the inability to record a vocal performance in languages unfamiliar to the vocalist. Thirdly, access to the resources needed and cost of recording vocal performances. Fourthly, manually creating a vocal performance is an arduous process, wherein a large quantity of a vocalist's time is dedicated to a single performance.

Accordingly, there is a need for methods and systems for capturing and identifying the unique vocal attributes of a vocalist and using these attributes to dynamically and accurately generate a vocal performance by that vocalist, and to identify when that vocalists' unique collection of vocal attributes is used to create dynamically generated vocal performances.

As such, it is an object of the present disclosure to provide a method and system for capturing and identifying and storing a vocalists' unique collection of vocal or voice attributes. It is further an object of the present invention to provide a means for associating a vocalist's unique collection of vocal attributes or voice model to generate dynamic outputs and vocal performances. It is further an object of the present invention to reduce the time and cost of a creating a vocalists' vocal performance. It is further an object of the present invention to allow the vocalists the ability to expand the number of recorded vocal performances created using their unique collection of vocal attributes or voice model.

### BRIEF DESCRIPTION OF THE FIGURES

FIG. 1 is a block diagram of a system of capturing, storing, identifying, and distribution an individual's unique collective vocal attributes or singing voice and dynamically generating a vocal performance using artificial intelligence according to an embodiment of the present disclosure.

### DETAILED DESCRIPTION

Systems and methods provided herein capture, identify, store and dynamically generate digital audio files of individuals' singing voices during ongoing or recorded vocal performances. Systems and methods digitally capture, identify and store unique vocal attributes of a persons' singing voices. These attributes include singing voices' range, timbre, flexibility, control, vibrato, resonance, articulation, expressiveness, stamina, tone and power. The attributes also comprise vocal traits including the use of feel, phrasing, pronunciations, language, articulation, dynamics, meter and rhythm.

Systems and methods comprise processing, normalizing, identifying, and storing these vocal attributes as a unique voice model. Voice and speech recognizer algorithms and an identifier code for a voice model may then be utilized to identify and retrieve a stored voice model. The voice and speech recognizer algorithms and the identifier code may then be used to generate dynamic outputs or digital audio files. The system may include hardware and software to provide deep neural networks used by artificial intelligence to carry out steps of the method.

Systems and methods may also reduce the time and cost of generating a vocal performance, to generate a vocal performance of an individual who can no longer perform vocally, to generate language translations of a vocal performance, and to account for the use of an individual's singing voice within a vocal performance.

An existing recording of a sung item of music may be analyzed in a similar manner as a live performance. Attributes of the vocalists singing voice may be extracted from a playing of the recording and a voice model and accompanying identifier similarly created.

Systems and methods may be useful when seeking to create a new song using a deceased person's singing voice. A particular vocalist may be deceased, retired, or unwilling or unable to sing or otherwise perform. Fans and other followers of the vocalist may desire new material from the artist or remakes of existing material. The present disclosure allows digital creation of new songs using a voice model for the vocalist such that the singing voice in the newly created song sufficiently resembles the singing voice of the vocalist. A typical listener would be unable to detect that the newly created song is a synthetic re-creation of the vocalist's voice, singing style, and vocal mannerisms.

The actual singing voice that is being recorded, analyzed, and converted into a voice model does not necessarily need to be that of a professional vocalist or well-known artist. A song or musical piece sung by any person can be analyzed and with voice model digitally stored as provided herein.

In an embodiment, the identity of a person who sung a particular song of interest to a user of the present disclosure need not be known. However, the person who sung the song may assert legal rights that the user of the present disclosure may need to respect.

Where appropriate, the system may compensate artists or their estates for usage of the artists' material. The artists may have copyright protection on some material. The present disclosure endeavors to respect legal rights and protection that persons or other legal entities may have on some material. In some cases, the system may secure permission from an artist, the artist's estate, and/or another entity before creating a voice model from the artist's material.

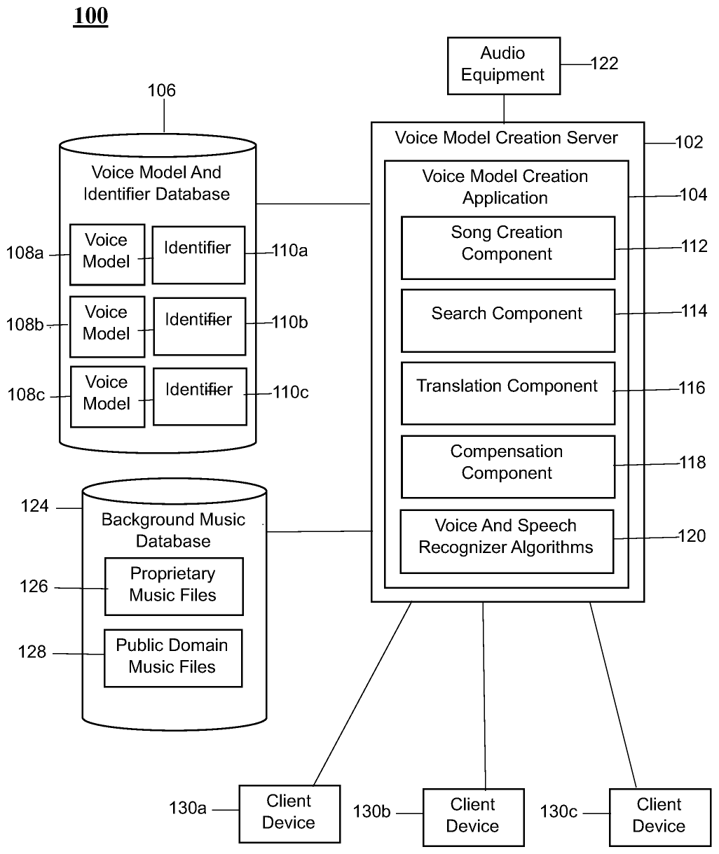

Turning to the figure, FIG. 1 is a block diagram of a system of capturing, storing, identifying, and distribution an individual's unique collective vocal attributes or singing voice and dynamically generating a vocal performance using artificial intelligence according to an embodiment of the present disclosure. FIG. 1 depicts components and interactions of a system 100.

System 100 comprises a voice model creation server 102 and a voice model creation application 104, referred to respectively hereafter for brevity as the server 102 and the application. System 100 also comprises a voice model and identifier database, voice models 108a-c, and identifiers 110a-c.

The server 102 may be at least one physical computer situation at one or more geographic locations. The application 104 executes at least on the server and provides much of the functionality provided herein. The application 104 may comprise numerous software modules and applications.

The application 104 analyzes live or recorded performances and creates voice models therefrom. The application 104 analyzes the many attributes listed above. The application 104 also processes, normalizes, identifies, and stores the captured attributes as a voice model 108a and provides an identifier 110a to the voice model 108a allowing the voice model 108a to be located.

Voice models 108a-c and their respective identifiers 110a-c are stored in the voice model and identifier database 106. While quantity three each of voice models 108a-c and identifiers 110a-c are provided by the system 100, in embodiments more than or less than quantity three of these components are provided.

Once a voice of a vocalist singing is recorded, it is fed to an artificial intelligence (AI) trainer. The identifier 110a is created which lists the attributes of the singing voice of the vocalist. A digital audio file in MP3 or WAV format is created which contains meta data or tags for the identifier 110a, the vocalist's name, the creator of the file, the date the file was created, the name of the song if known, the musical genre, for example rock, jazz, hip hop, or country, an image of the vocalist and any applicable copyright notices. The meta data or tags embedded into the digital audio file may provide for tracking use and legal protection for ownership of the digital audio file and associated voice model 108a.

The system 100 also comprises a song creation component 112 which creates songs using voice models 108a-c. In an embodiment, a user may want a song by a particular vocalist that the vocalist has never sung before. If a voice model 108a has been created and stored for that vocalist, the song creation component 112 can create the song using that vocalist's voice which includes many or most of that vocalist's singing characteristics. As noted, the vocalist's permission may need to be secured for this project. A deceased vocalist for whom a voice model 108a has been created and stored can be the vocalist for a song that the vocalist never sang when alive. Compensation to that vocalist's estate may be required.

The application 104, via the song creation component 112, may deploy at least one voice and speech recognizer algorithm 120 to analyze the singing voice, to match attributes, and locate the at least one voice model 108a for the particular vocalist of interest. The at least one algorithm 120 generates dynamic outputs and digital audio files associated with the at least one voice model 108a for the vocalist in supporting the song creation component 112 in creating the song.

The search component 112 of the application 104 is used to search the voice model and identifier database 106 for the particular voice model 108a of interest. The search component 112 may search for a particular identifier 110a or it may search for a combination of attributes. In an embodiment a user may want a song produced in the voice of an unknown person or even friend or family member who sang a different song wherein the user is very interested in that particular voice.

The system 100 may analyze that different song and create a voice model 108a for the unknown person who sang that different song and then produce the song of interest using that voice model 108a. Alternatively or additionally, the system 100 may cause the search component 112 to search the voice model and identifier database 106 for at least one voice model 108a with vocal attributes that resemble the attributes of the singing voice of the unknown person and use the located at least one voice model 108a to create the song of interest that the user has requested.

The system can extract or create more than one voice model 108a-c and combine some attributes of the multiple voice models 108a-c while excluding others to create a synthetic voice that resembles the voice of the unknown person. The song creation component 112 of the application 104 can combine different aspects of these functionalities and perform tests until the synthetically created singing voice very closely resembles the singing voice of the individual who sang the song that piqued the interest of the user who requested the system 100 to create a different song in that individual's voice.

In an embodiment, a voice model 108a for a deceased artist such as Frank Sinatra may be created and that voice model 108a may be used to create a contemporary song sung in Sinatra's voice. This may require the permission of the estate of Frank Sinatra and likely royalties paid to the estate.

The system 100 also comprises a translation component 116 that translates sung material from one language to another. A voice model 108a created from songs sung in English, for example, may be used to create a song sung in another language, for example Italian. The translation component 116 has access to many languages. In addition to translating, the translation component 116 also provides vocal variety and accenting such that if a song sung by Frank Sinatra in English is translated to Russian, a language Mr. Sinatra did not speak, the song does not sound like an English-speaking person with a great singing voice trying to sing in Russian. Rather, the song is produced by the system 100 such that it sounds as if Mr. Sinatra had been trained in the Russian language such that his singing voice accounts for the vocal nuances of that language for a male vocalist of Mr. Sinatra's age and era in which Mr. Sinatra lived.

The system 100 also comprises a compensation component 118 that compensates artists and others who have copyright protection on material that they have produced. The present disclosure observes legal rights of creative parties that produced material or their estates when applicable.

Audio equipment 122 is hardware and software used to capture live performance by vocalists, analyze singing voices, and store sung material. The system 100 performs its methods as described herein using the application 104, its components of the application 104, and other components to create voice models 108a-c and produce songs therefrom. Audio equipment 122 may be known in the arts and may comprise devices that reproduce, record, or process sound. This includes microphones, radio receivers, AV receivers, CD players, tape recorders, amplifiers, mixing consoles, synthesizers, effects units, headphones, and speakers.

The system 100 also comprises the background music database 124 that stores background music that may be added to songs created using voice models 108a-c as described herein. The background music database 124 contains proprietary music files 126 wherein legal rights of artists' or their estates must be observes. The compensation component 118 negotiates and compensates for use of material drawn from the proprietary music files 126. The background music database 124 also contains public domain music files 128 containing music in the public domain that may be freely used without compensation to any party.

The system 100 also comprises client devices 130a-c by which customers or other users of the services provided by the system may contact the system and request musical material as described above. In embodiments, the services of the system provided herein may be offered on a commercial basis.

What is claimed is:

1. A system for creating a song using vocal attributes extracted from a singing voice of an individual, comprising:
a computer and application executing thereon that:
digitally captures a plurality of vocal attributes of a singing voice of an individual,
processes, normalizes, identifies, and stores the captured attributes as a voice model, and
based on dynamic outputs and digital audio files associated with the voice model, generates a performance of a new song created with the individual's singing voice.

2. The system of claim 1, wherein the system provides an identifier code for the voice model, the code used for storing and indexing the model.

3. The system of claim 1, wherein the vocal attributes comprise at least one of range, timbre, flexibility, control, vibrato, resonance, articulation, expressiveness, stamina, tone and power of the singing voice.

4. The system of claim 1, wherein the vocal attributes further comprise vocal traits comprising use of at least one of feel, phrasing, pronunciations, language, articulation, dynamics, meter and rhythm.

5. The system of claim 1, wherein the attributes further comprise vocal ranges of the individual comprising at least one of soprano, mezzo-soprano, tenor, baritone, and bass.

6. The system of claim 1, wherein the voice attributes are captured from at least one of a live session with the individual and a recording of the individual's singing voice.

7. The system of claim 1, wherein background music is added to the generated performance.

8. The system of claim 1, wherein the individual is compensated for the use of the singing voice in generating the performance.

9. The system of claim 2, wherein voice and speech recognizer algorithms and the identifier code for the voice model are used to identify and retrieve the voice model and are used to generate one of dynamic outputs and digital audio files.

10. A method for producing a song with a singing voice not associated with the song, comprising:
a computer receiving a request for a first song to be produced with a vocalist voice matching a singing voice associated with a second song;
the computer searching a database of voice models for at least one model with attributes resembling the singing voice;
the computer locating, based on the searching, at least a stored first voice model resembling the singing voice; and
the computer producing the first song using the at least first voice model.

11. The method of claim 10, further comprising the computer matching attributes drawn from the at least first voice model with attributes of the singing voice.

12. The method of claim 10, further comprising the computer deploying voice and speech recognizer algorithms to analyze the singing voice, to match attributes, and to locate the at least one the voice model.

13. The method of claim 12, further comprising the computer deploying the voice and speech recognizer algorithms to generate one of dynamic outputs and digital audio files associated with the at least one voice model.

14. The method of claim 10, wherein an identity of a person associated with the singing voice is unknown.

15. A system for synthetically producing vocal material, comprising:
a computer and application executing thereon that:
receives a request for a first song to be sung by an artist,
receives a message that the artist is permanently unavailable,
accesses at least a second song previously recorded by the artist,
captures a plurality of vocal attributes from the at least second song,
produces and stores a voice model based on the plurality of vocal attributes, and
using the voice model, produces the first song, the first song playable in the voice of the artist.

16. The system of claim 15, wherein the artist's status of unavailable comprises the artist one of being deceased, retired, and physically unable to perform.

17. The system of claim 15, wherein the system determines that the first song has not previously been recorded by the artist.

18. The system of claim 15, wherein the vocal attributes comprise at least one of resonance, tone and power of the singing voice.

19. The system of claim 15, wherein the vocal attributes further comprise vocal traits comprising use of at least one of feel, phrasing, pronunciations, language, articulation, dynamics, meter and rhythm.

20. The system of claim 15, wherein the system compensates one of the artist and an estate of the artist for use of a facsimile of the voice of the artist.
